(19) United States
(12) Patent Application Publication
(10) Pub. No.: US 2013/0139068 A1
(43) Pub. Date: May 30, 2013

(54) SYSTEM AND METHOD FOR ENHANCING SPORTS GAMEPLAY AND COMMUNICATION

(71) Applicant: Mark Bowring, Dallas, TX (US)

(72) Inventor: Mark Bowring, Dallas, TX (US)

(73) Assignee: MEDIADAY INCORPORATED, Dallas, TX (US)

(21) Appl. No.: 13/814,479

(22) PCT Filed: Aug. 5, 2011
(86) PCT No.: PCT/US11/46727

§ 371 Date: Feb. 5, 2013

(30) Foreign Application Priority Data
Aug. 5, 2010 (US) 61371063

(51) Int. Cl. G06F 3/048

(52) U.S. Cl. CPC G06F 3/048
USPC 715/747

(57) ABSTRACT

According to an embodiment of the disclosure, a wrist coach system (220) comprises a layout module and an output module. The layout module provides a user (210) with menu features (232) and navigational features (236). The menu features and the navigational features are configured to allow the user to create a play. The output module provides wrist coach instructions for the created plays. The wrist coach instructions are configured to be viewed from a wrist coach (310, 320) on a wrist of a player. In particular configurations, the wrist coach is an electronic wrist coach (320) that receives wireless instructions.

### CROSS-REFERENCE TO RELATED APPLICATIONS

This application claims priority to U.S. Provisional Application No. 61/371,063 entitled SYSTEM AND METHOD FOR ENHANCING SPORTS GAMEPLAY AND COMMUNICATION, which was filed on Aug. 5, 2010.

### TECHNICAL FIELD

The present disclosure is directed, in general, to sport systems, and more specifically, to a system and method for enhancing sports gameplay and communication.

### SUMMARY

According to an embodiment of the disclosure, a wrist coach system (220) comprises a layout module and an output module. The layout module provides a user (210) with menu features (232) and navigational features (236). The menu features and the navigational features are configured to allow the user to create a play. The output module provides wrist coach instructions for the created plays. The wrist coach instructions are configured to be viewed from a wrist coach (310, 320) on a wrist of a player. In particular configurations, the wrist coach is an electronic wrist coach (320) that receives wireless instructions.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified block diagram illustrative of a communication system that can be utilized to facilitate communication between endpoint(s) and endpoint(s) through a communication network, according to particular embodiments of the disclosure;

FIGS. 2A and 2B illustrate aspects of a wrist coach system, according to an embodiment of the disclosure;

FIGS. 3A, 3B, 3C, 3D, and 3E show examples of displaying plays on a wrist coach, according to embodiments of the disclosure;

FIGS. 3F and 3G show wrist coaches, according to further embodiment of the disclosure;

FIGS. 4A and 4B illustrate a playbook system, according to an embodiment of the disclosure;

FIGS. 4C and 4D illustrate another aspect of the playbook system, according to an embodiment of the disclosure;

FIG. 5 illustrates a locker room system, according to an embodiment of the disclosure;

FIG. 6 illustrates an analysis system, according to an embodiment of the disclosure;

FIG. 7 illustrates a scouting system, according to an embodiment of the disclosure;

FIG. 8 illustrates a comment system, according to an embodiment of the disclosure; and

FIG. 9 is an embodiment of a general purpose computer that may be used in connection with other embodiments of the disclosure to carry out any of the above-referenced functions and/or serve as a computing device for the endpoint(s) of FIG. 1.

### DETAILED DESCRIPTION

The FIGURES, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

FIG. 1 is a simplified block diagram illustrative of a communication system 100 that can be utilized to facilitate communication between endpoint(s) 110 and endpoint(s) 120 through a communication network 130, according to particular embodiments of the disclosure. As used herein, “endpoint” may generally refer to any object, device, software, or any combination of the preceding that is generally operable to communicate with another endpoint. The endpoint(s) may represent a user, which in turn may refer to a user profile representing a person. The user profile may comprise, for example, an address for the user, a user name, a passcode, other user information, or any combination of the preceding. Additionally, the endpoint(s) may represent a device that comprises any hardware, software, firmware, or combination thereof operable to communicate through the communication network 130.

Examples of an endpoint(s) include, but are not necessarily limited to, a computer or computers (including servers, applications servers, enterprise servers, desktop computers, laptops, netbooks, tablet computers (e.g., IPAD), a switch, mobile phones (e.g., including IPHONE and Android-based phones), networked televisions, networked disc players, components in a cloud-computing network, or any other device or component of such device suitable for communicating information to and from the communication network 130. Endpoints may support Internet Protocol (IP) or other suitable communication protocols. Endpoints may additionally include a medium access control (MAC) and a physical layer (PHY) interface that conforms to IEEE 801.11. If the endpoint is a device, the device may have a device identifier such as the MAC address and may have a device profile that describes the device.

The communication network 130 and links 115, 125 to the communication network 130 may include, but is not limited to, a public or private data network; a local area network (LAN); a metropolitan area network (MAN); a wide area network (WAN); a wireline or wireless network (GSM, CDMA, LTE, WIMAX, or the like); a local, regional, or global communication network; portions of a cloud-computing network; a communication bus for components in a system; an optical network; a satellite network; an enterprise intranet; other suitable communication links; or any combination of the preceding. In particular embodiments, portions of the links 115, 125 or communication network 130 may be on the Internet.

Although endpoint generally appears as being in a single location, the endpoint(s) may be geographically dispersed, for example, in cloud computing scenarios. As used in this document, “each” may refer to each member of a set or each member of a subset of a set.

When the endpoints(s) 110, 130 communicate with one another, any of a variety of security schemes may be utilized. As an example, in particular embodiments, endpoint(s) 120 may represent a client and endpoint(s) 130 may represent a server in client-server architecture. The server and/or servers may host a website. And, the website may have a registration process whereby the user establishes a username and password to authenticate or log in to the website. The website may additionally utilize a web application for any particular application or feature that may need to be served up to the website for use by the user.

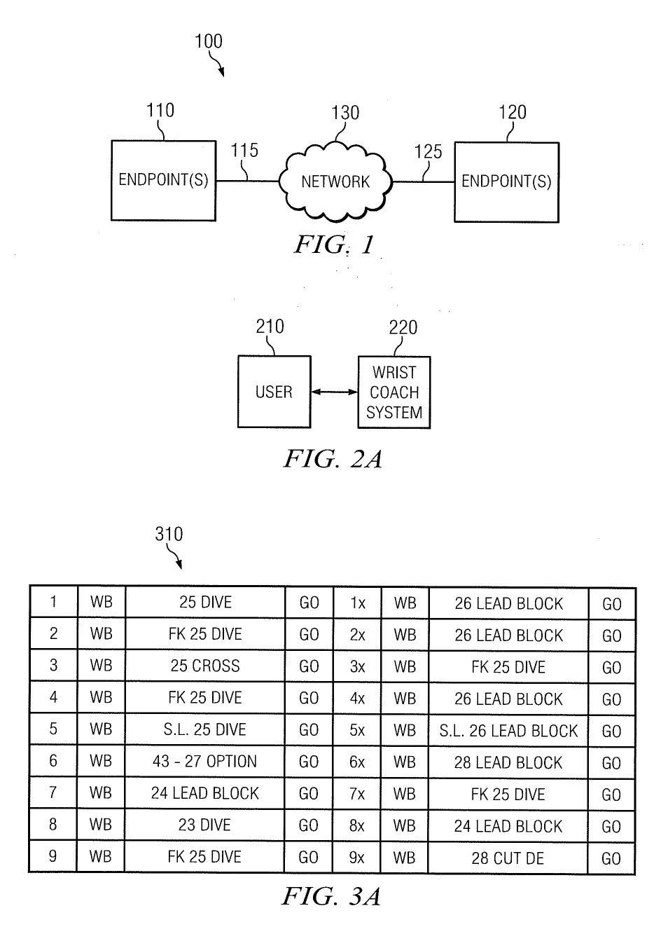

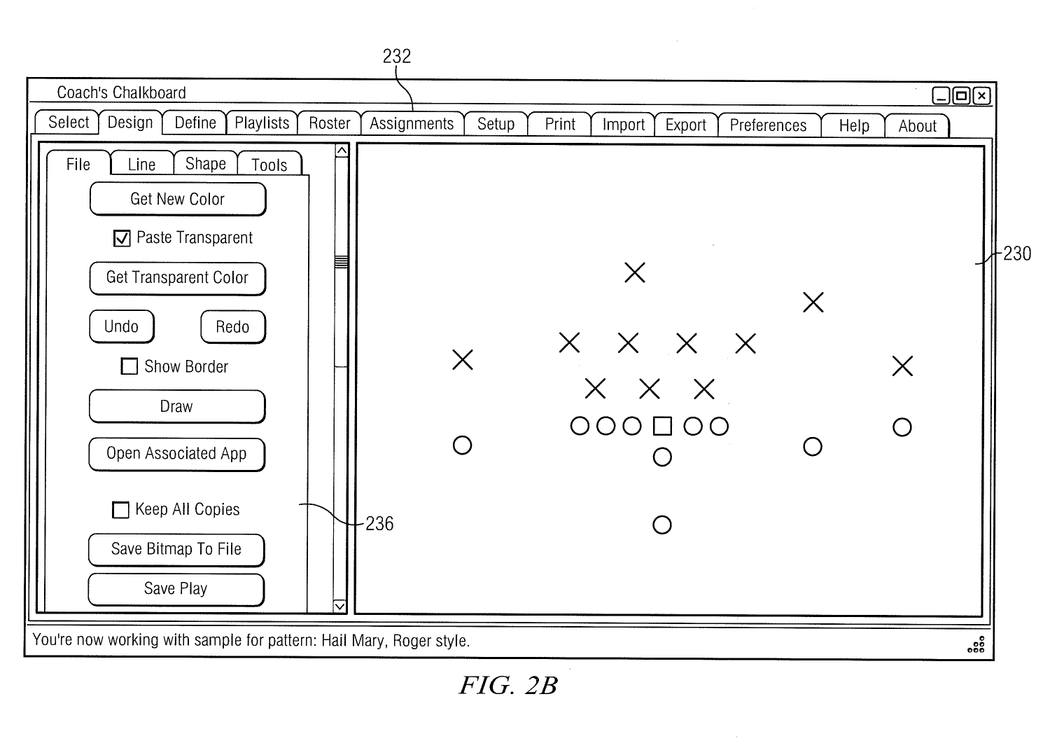

FIGS. 2A and 2B illustrate aspects of a wrist coach system 220, according to an embodiment of the disclosure. In FIG. 2A, a user 210 accesses a wrist coach system 220. The user 210 and the wrist coach system 220 may correspond to endpoint(s) 110 and 120 described in FIG. 1. As described above, in particular embodiments, this user 210 may access the wrist coach system 220 via a computing device such as computer. In particular embodiments, some or all of the wrist coach system 220 may be on a website (hosted by one or more computing devices, servers, or databases). In other embodiments, some or all of the wrist coach system 220 may be on a local client associated with a computing device used by a user 210. In particular embodiments, the user 210 enters a username and password for authentication to the website corresponding to the wrist coach system 220.

As described in further details below, the wrist coach system 220 in particular embodiments may operate as a Software as a Service (SaaS) website that introduces a new method to sideline football play calling utilizing a wrist coach containing plays cards with specific instruction to each player. The instructions on such play cards include, but is not necessarily limited to, formations, the play, the player's assignment, and the cadence for each play called.

In particular embodiments, the wrist coach system may be designed to assist youth football market from ages 5 (flag football) to 18 (varsity football) with an intelligent play calling system that will create an on-field competitive advantage. In other embodiments, the wrist coach system 220 may be utilized in other settings, such as collegiate or professional football settings. For example, in collegiate settings, the wrist coach system 220 may be utilized for NCAA football (any division) or for intramural sports.

FIG. 2B shows an illustrative layout that may be displayed to a user 210 who has accessed the wrist coach system 220. Although an example layout is shown, other layouts may include more, less, or different component parts. As seen in view 230, an 11-man offensive and defense football formation is shown. Although a formation for 11-man football is shown, the wrist-coach system 220 may also be utilized for six man football, flag football, and 7-on-7 football. Through screens such as this, a user may be able to select template plays (e.g., predefined by the wrist coach system 220) or create their own plays. For each play, at least a formation and action for players can be assigned. Additionally, the play can correspondingly be named. For example, the play in view 230 is called “Hail Mary, Roger Style.” For this entitled play, the user can draw up the actions of the offensive formation (e.g., as shown by the circles and squares on the bottom half of the screen). Menu or navigational features 232 and 236 may assist play creation and review. For example, using the line feature of navigation feature 236, a user 210 may be able to illustrate what a particular player is doing. In such embodiments, the illustration of the play may either be static “chalk-board” style play creation or dynamic moveable play creation where one can see movement of the play.

Further discussion of both styles will be described with reference to various embodiments below.

In particular embodiments, the wrist coach system 220 may be particularly useful for an inexperienced coach who either doesn't have a pre-set number of plays or is coaching a youth team for the first time. In such scenarios, the wrist coach system 220 may provide template plays for the coach appropriate to the level of play.

In particular embodiments, the wrist coach system 220 is highly configurable. For example, some coaches may wish to scan their existing plays and “import” them in to the wrist coach system 220 (e.g., as seen on the import tab of navigation feature 232). Alternatively, a coach may wish to “export” them from the wrist coach system, using the export tab of navigation feature 232. Other tabs of navigation feature 232 show other example configurations, including a roster tab showing players on the team, a playlist tab showing all the plays.

While certain embodiments will describe offensive schemes for a sport, it should be understood that various embodiments disclosed herein may equally be used for defensive schemes. Additionally, although particular sports (e.g., football) will be described as availing from embodiments of this disclosure, other sports may avail from various embodiments of the disclosure. Further, non-sport activities may avail from embodiments of the disclosure. Therefore, although some embodiments will specifically reference “football,” it will be understood that other activities—including other sports—can avail from embodiments of the disclosure.

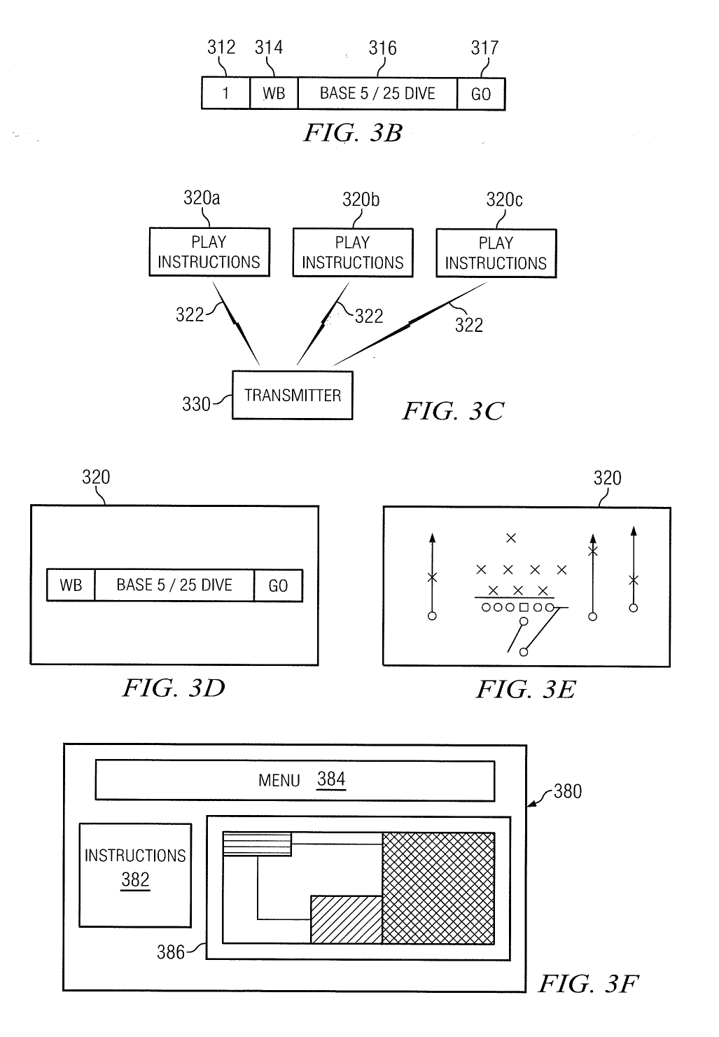

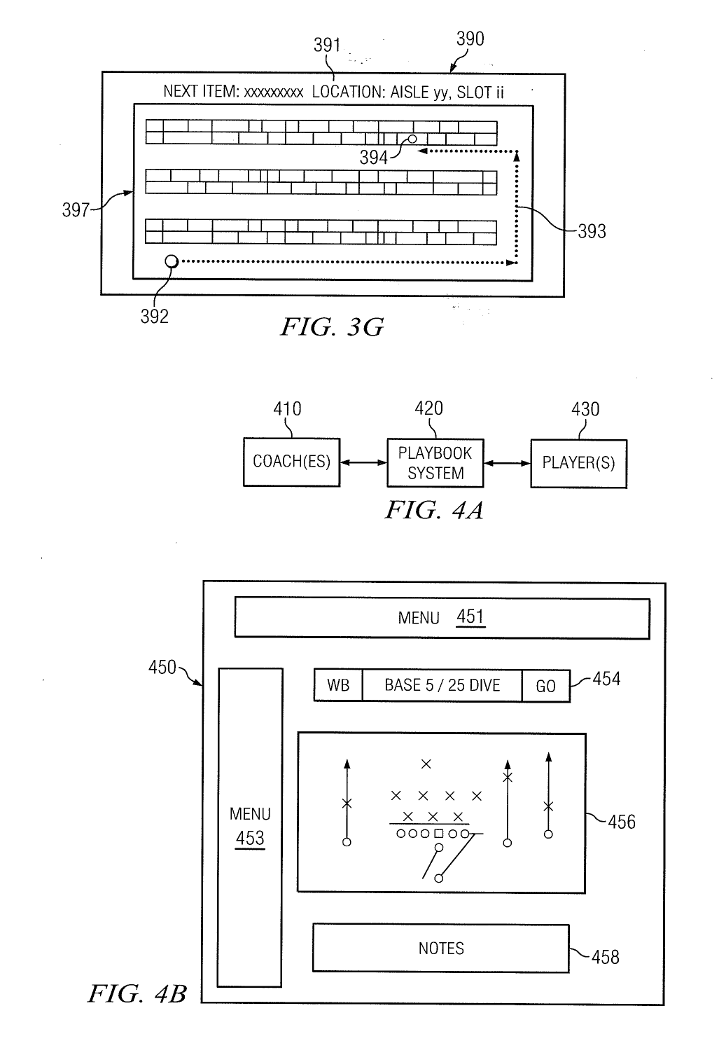

One of the ultimate outputs for the wrist coach system 220 is the display on a so-called “wrist coach” as described with reference to FIGS. 3A, 3B, 3C, 3D, and 3E. In particular embodiments, the coach may choose the particular plays to be displayed and the ordering of the plays to be displayed. Other outputs include digital outputs, for example, using the export tab. Alternatively, one may print out the plays to study, for example, in a notebook using the “print” tab.

FIGS. 3A, 3B, 3C, 3D, and 3E show examples of displaying plays on a wrist coach, according to embodiments of the disclosure.

FIG. 3A shows a version of the wrist coach 310. The wrist coach 310 is particular to a player. Here, wrist 310 shows information for a lineman. In particular embodiments, each player on the team may have their specific version of wrist coach to view. As seen in FIG. 3A, wrist coach 310 includes plays 1-9 and plays 1x-9x.

FIG. 3B shows the instructions for a particular line when a particular play has been called. A coach may have called play 1. Accordingly, the lineman wearing the wrist coach 310 in FIG. 3A looks to the chart for corresponding information for play 1 indicated by designator 312. He will find that for play 1, the formation 314 is a wishbone formation (WB), the instructions 316 for his position are “Base 5/25 Dive”, and the cadence 318 for the call is “Go.” In its simplest form, the coach may simply yell “1” to call play 1. However, a variety of codes may be also be communicated so that the opposing team may not understand what play is being called. For example, a special code may be displayed (e.g, circle with a star), which the player knows means “1.”

Although a specific type of wrist coach 310 is shown in FIGS. 3A and 3B, a variety of other different configurations for the wrist coach may be utilized. And, such other configurations may avail from teachings of this disclosure.

FIG. 3C illustrates another manner of getting play information to players, according to an embodiment of this disclosure. In FIG. 3C, the wrist coaches are electronic wrist coaches 320 (320a, 320b, 320c) that can electronically display information and wirelessly receive signals from a transmitter 330. The display, itself, on the electronic wrist coach 320 may use any of a variety of display technologies, including electronic ink technologies and light emitting diode technologies. Additionally, in particular, embodiments, the display may be made of a material (e.g., aluminosilicate glass) designed to take hard hits.

In embodiments, such as FIG. 3C, the transmitter 330 wirelessly sends a signal 322 to the wrist coaches 320. Just like wrist coach 310, electronic wrist coach 320 may be specific to players. The transmitter 330 may either be associated with a device or another player on the field, for example, the quarterback when the sport is football. Each of the wrist coaches may have any suitable receiver(s) and any suitable antenna(s). In particular embodiments, the electronic wrist coaches 320 may not only be capable of receiving signals 322, but may also be capable of transmitting signals 322.

The wireless signal 322, itself, may take on any of variety of forms. Additionally, in particular embodiments, it may be encrypted. Further, the wireless signal 322 may be the same or different for each respective player.

In particular embodiments, the electronic wrist coach 320 may also include non-visual indicators to either call plays or change plays. For example, the electronic wrist coach 320 may include a slight electrical shock or vibration to indicate a play change. As one illustrative example, the play may be called and viewed by the players using electronic wrist coach 320. Then, when the players reach the line of scrimmage, the coach or quarterback may choose the alternative corresponding play to the particular play. Accordingly, the electronic wrist coach 320 may use the non-visual indicator feature to notify all offensive players that the play has been changed. The transmission of this play change may either come from the quarterback, sideline, coach's box, or other suitable location.

Using the system of FIG. 3C, one can see that there is a reduced likelihood that an opposing team will somehow understand the plays being called.

FIGS. 3D and 3E show examples displays that may be used on electronic wrist coach 320. FIG. 3D shows only the play, itself, which may be specific to the particular player. FIG. 3E shows a diagram of the play. In particular embodiments, a different color may be used to show the specific instructions for the player. In other embodiments, both the play and the diagram of the play may be shown. Using the system of FIG. 3C, one may utilize more plays that can fit on a traditional wrist coach 320. Furthermore, plays may be communicated more quickly. For example, a coach in the stadium “box” may view a particular formation of the opposing team and quickly initiate instructions for the play, which is nearly instantaneously displayed on the electronic wrist coach 320.

In addition to the view display, a coach may also communicate other information to the player through the wrist coach 320, including, for example, graphics or text. As one example, the text to a quarterback may say something like “watch your backside—defensive end has been getting through.”

In addition to the benefits mentioned above, other benefits may be availed from wrist coach system described herein, including:
Allows new players time to develop without fear of failure;
Gives each player the benefit of knowing what to do in any formation for every play called from the sideline regardless of who is on the field at the time;
Allows coaches to focus on teaching technique and play instruction during practice;
Speeds up practices and enhances player preparation at every position;
Saves coaches time during game plan preparation and enhances the team's play execution on the field;
Gives teams a competitive advantage because of their ability to operate out of a no-huddle/hurry-up offense.
Eliminates most broken plays and false starts.
Allows a team to flex in and out of formations during games, giving players the ability to effectively adjust real time while on the field.

FIGS. 3F and 3G show wrist coaches 380 and 390, according to further embodiment of the disclosure. According to particular embodiments, wrist coaches 380 and 390 may correspond to one of the endpoint(s) 110 or endpoint(s) 120 of FIG. 1 and communicate with a system (which may correspond to the other of the endpoint(s) 110 or endpoint(s) 120 of FIG. 1) using the communication techniques described with reference to FIG. 1, which includes wireless communications.

As indicated above, in particular embodiments, the systems described herein may be used in non-sport settings. Wrist coaches 380 and 390 are two non-limiting examples of non-sport settings.

As a first example, with reference to the wrist coach 380 of FIG. 3F, a phone or electrical repairman may be working on a pole or tower to repair phone or electrical equipment. In such settings, the repairman may wear the wrist coach 380 to receive instruction information on the repair. For example, pictures or a schematic 386 of the component needing repair may be provided along with instructions 382 about different components. Alternatively, instructional video or explanatory visuals may be provided. The wrist coach 380 may additionally have a variety of other features, for example, a menu 384 that allows navigation of various screens on the wrist coach 380, voice recognition features, voice/video communication features, video/image capture features, and location determination features (using GPS, cell-towers, or the like).

To ensure up-to-date information, the wrist coach 380 may be one of the endpoints 110 or 120 described in FIG. 1 and be wirelessly connected to a network. Using such a wireless network, the wrist coach may receive or provide information in real-time.

As a non-limiting example use of the wrist coach 380, a repairman may arrive at a designated location atop a pole or tower. Upon arriving, the repairman may determine a particular component is installed (the components types of which may vary greatly). The repairman may either ask for information on the particular component, for example, using voice recognition features or using the menu 384. In response to such inputs, the wrist coach may display a variety of information, including pictures or a schematic 386, videos, illustrations, and instructions 382. If the component is unknown, the repairman may be able to take a picture of the component and send it to a central station that may provide support for the repairman. In particular embodiments, the repairman may communicate with the central station using voice and/or video features to facilitate such a repair, sharing (as appropriate) the work being done (e.g., via video or pictures) and receiving instruction through the wrist coach 380. In addition to schematic-type instruction information, the wrist coach 380 may also provide a series of trouble-shooting steps.

As another non-limiting example, with reference to the wrist coach 390 of FIG. 3G, a “picker” at a so-called “pick, pack, and ship” facility may wear the wrist coach 390 to aid in the picking process. As will be recognized by those of ordinary skill in the art, “pickers” in such facilities are tasked with gathering products corresponding to an order. For example, the order may have been placed at an online website such as Amazon.com and the picker gathers the information corresponding to the order. After all the items for a certain order are gathered, the picker moves the order to a location for shipping and moves on to the next order. Alternatively, the picker may gather multiple orders at one time (e.g., using a collective vehicle that segregates orders, for example, into bins) before sending the collective orders for packing and shipment at one or more locations. In particular embodiments, the “pick, pack, and ship” facility may be sending orders for several different labels (e.g., Amazon and Best Buy). Through this pick, pack and ship process, there are a lot of logistics about what items need to get what areas and how to best gather products. This is where the wrist coach may be utilized. The wrist coach 390 informs and instructs the pickers as to the next task—whether it be a task to gather items or task to take items to a different location.

As an example, with reference to FIG. 3G, the wrist coach 390 include a map 397 of a portion of a warehouse. The map 397 may show aisles for the products along with a location 392 of the person currently wearing the wrist coach 390. As instructions as the next location to move, the wrist coach 390 may instruct the picker to pick up another product for the order. Information shared in these instruction may include instruction item 391 that may include a description of the item and the location. Other information shared in the instructions may include a map indicator 394 that show the physical location of the item to be picked up and a route 393 that shows the quickest route to the product (as indicated by the map indicator 394). Additional information in the instructions may include, but is not limited to, picture of the product being picked up.

Upon arriving at the map indicator 394, any of variety of techniques may be used to indicate to a system networked to the wrist coach 390 that a product has been picked up. For example, the wrist coach 390 may have a bar code reader and/or an RFID reader that not only indicates that the correct item has been picked, but also indicates that the item has been retrieved. The networked system may use such information to keep track of the number of items in stock, for example, to obtain more product (as necessary) in the supply chain.

After gathering a particular product, the wrist coach 390 may provide further instructions about the next product in an order or indicate that the products in the order need to be delivered to a particular location for packing and shipping (which may be different if the facility is servicing different clients). Because the wrist coach 390 may be wireless networked to a system, the instructions may be not only dynamically updated, but also detailed. For example, if multiple individuals are wearing wrist coaches 390 and one person is gathering product more quickly, the list of items to gather for a particular wrist coach 390 can dynamically be shifted from one wrist coach to another as circumstances change. As another example of the dynamic update, a person may have begun collecting items for orders when a new order has arrived. The system may determine that a particular item in a recent order could be gathered by a particular person that is already gathering the same item for a different order. The instructions in particular embodiments may be immediate.

As an example of the detailed instructions, a wrist coach may inform a picker that two items of the same product are being gathered for two different orders. Thus, the wrist coach may inform the picker to place one of the items in a certain bin (corresponding to the order) and another of the same item in another bin (corresponding to a different order).

Because instructions may be detailed and dynamically updated, the logistics in the picking, packing, and shipping process may be enhanced to increase efficiency.

Although very specific examples for the wrist coach are described above, it should be understood that the wrist coach may be used in a variety of other setting as well. In particular, the wrist coach may be used in any setting where instructions need to be provided to a wearer of the wrist coach in an updated and dynamic fashion. Other non-limiting examples include hospitals personnel wearing wrist coaches to receive information on patients, military personnel wearing wrist to receiving dynamic information (maps, videos, pictures, instructions, location of colleagues) on tactical operations, and policeman and/or fireman wearing wrist coaches to receive dynamic information to carry out their jobs and/or to be dispatched to a particular location.

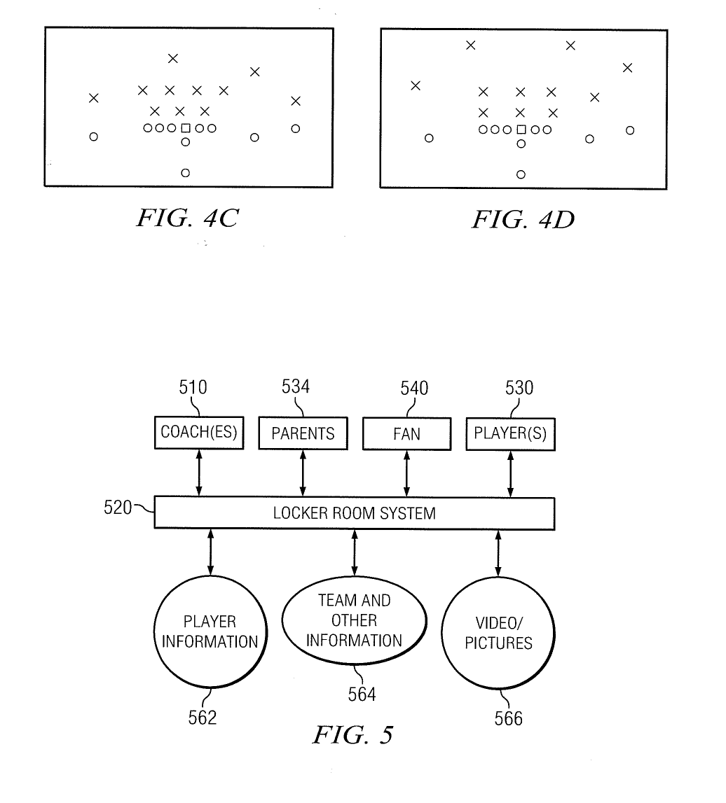

FIGS. 4A and 4B illustrate a playbook system 410, according to an embodiment of the disclosure. In conventional sports settings (e.g., football), coaches provide notebooks of plays to a player with hopes the player will study such plays. Additionally, when preparing for the games or providing pre or post-game information a coach may provide handouts. The playbook system 410 described with reference to FIGS. 4A and 4B describes a new way for coaches to communicate with players. In particular embodiments, the playbook system 410 of FIGS. 4A-4B may be used in conjunction with the wrist coach system 220 described above.

FIGS. 4A and 4B illustrate aspects of the wrist-coach, according to an embodiment of the disclosure. In FIG. 4A, both coach(es) 410 and player(s) 430 access the playbook system 420. Although coaches 410 and players 420 are shown accessing the system in this embodiment, in other embodiments, other types of users may access the playbook system 410 (e.g., team trainers and the like).

Similar to that described with reference to FIGS. 2A-2B, the coach(es) 410 and player(s) 430 may correspond to endpoints 110 and 120 described in FIG. 1. As described above, in particular embodiments, coach(es) 410 and player(s) 430 may access the playbook 420 via a computing device. In particular embodiments, some or all of the playbook system 420 may be on a website (hosted by one or more computing devices, servers, or databases). In other embodiments, some or all of the wrist coach system 420 may be on a local client associated with the computing device used by a user such as coach(es) 410 and/or player(s) 430. In particular embodiments, the coach(es) 410 and player(s) 430 enter a username and password for authentication to the website corresponding to the playbook system 420.

FIG. 4B shows an example display, which may be displayed on or by a device used by coaches 410 and/or players 430. For example, in some embodiments, a computing device with a display (e.g., a laptop) may be used to access the system. In other embodiments, the display may be a projected display.

In particular embodiments, the views of a particular user may be different than views by other users. For example, a coach may have a different view than a player. Additionally, a defensive back player may have a different view than a quarterback.

In particular embodiments, the playbooks system 420 may be used to prepare players for practice and/or games. For example, prior to practice, a player may log-in to the system and study the plays specific to his or her position and/or positions.

The playbook system 420 in particular embodiments may be used as a player preparation tool and may include some or all of the following features:
Display of formations and/or plays
Display of formations and/or plays of one or more opposing teams;
Display or provide formation descriptions;
Display or provide play descriptions;
Display or provide player assignment descriptions;
Display or provide game plan for a particular game;
Display or provide scouting notes;
Display or provide wrist coach view of play; and
Display or provide notes on effectiveness of plays

To monitor whether or not players are actually studying the “playbook,” the playbook system 420 may also have a monitoring and reporting feature. This monitoring and reporting feature may measure how much time a user has actually spent on the playbook system 420. Additionally, the monitoring system may provide granular level statistics, for example, Player A spent B minutes on Play C, D minutes on Play E and so forth. The monitoring system may report such information in any suitable fashion to coach(es) and/or other designated users.

The playbook system 420 may also store a game plan, itself, along with a coach's pre-game and post-game notes. In particular, embodiments, any of this information may be printed (e.g., on a coach's game card) in preparation for the game.

FIG. 4B shows an example view 450 of a user that may have logged-in to the playbook system 420. Although a particular arrangement of example features are shown, it should be expressly understood that a variety of other arrangements may be utilized. Menus 451 and 453 may allow a user to navigate through various features in the system (e.g., from play-to-play). Currently displayed in view 450 is play instructions 454. In particular embodiments, the look of play instructions 454 may be the same as what a view of the same play would look like on a wrist coach. Below the play instructions 456 is a play view 456, showing what the play actually looks like along with a “chalk-board” style description of each player's action. Although a “chalk-board” style description of the action is shown in this embodiment, in other embodiments, the screen may show a dynamic moveable play showing players in actual motion. In such embodiments, the menus 451, 453 or other control functionalities may be provided to set the play in motion. In particular embodiments, the play view 456 may have a zoom feature such that a player can only look at his or her position.

Below the play views 456 is notes section 458. The notes 458 may be used for a variety of purposes, providing input that a player may need to know in executing the play. In particular embodiments, the notes may be adjacent the play view 456 or may pop-up onto the play view 456. The notes may include, but is not limited to play descriptions; player assignment descriptions; game plan information and/or scouting notes.

In particular embodiments, an individual may scout an opposing team and provide as much information as possible about the opposing team into the playbook system 420, for example, in the notes or formation and/or play information about a team.

FIG. 4C and 4D illustrate another aspect of the playbook system 420, according to an embodiment of the disclosure. FIGS. 4C and 4D include the same offensive formation and different defensive formations. Using menu features 451, 453 or other suitable function toggles, one may change one or both of the offensive and defensive formations. And, for each combination, there may be a specific sets of notes or game plan information. For example, if a team is looking at the view of FIGS. 4C and 4D from an offensive positions, there may be a different set of notes for the view of FIG. 4C than there is for the view of FIG. 4D.

Although the views shown in FIGS. 4C and 4D show both offensive and defensive positions, in particular embodiments, one may choose to display one or the other.

FIG. 5 illustrates a locker room system 520, according to an embodiment of the disclosure. The locker room system may be used in conjunction with or separate from the other systems described herein. Additionally, the locker room system 520 may be accessed in a similar manner to that described above. For example, the users such as coach(es) 510, parents 534, fans 540, and player(s) 530 as well as the locker room system 520, itself, may correspond to endpoint(s) 110 and endpoint(s) 120 of FIG. 1. The locker room system 520, itself, may be associated with a website that allows access to users such as coach(es) 510, parents 534, fans 540, and player(s) 530, for example, using the appropriate authentication scheme.

Individuals accessing the locker room system 520 may have varying roles that define what type of content the particular person has access to in the locker room system 520. The four example roles shown in this embodiment are: coach(es) 510, player (s) 530, parent(s) 534, and fans 540. Although only four roles are shown in this embodiment, in other embodiments other types of roles may be utilized. Other examples of types of roles will be shown with reference to other embodiments.

In particular embodiments, the locker room system 520 may serve as an information repository, providing a variety of different types of information to users. The locker room system 520 may be viewed as a limited social network for those needing information corresponding to a particular team. In addition to the information described above with referenced to other embodiments, the following are non-limiting examples of other types of information that may be obtained from the locker room system 520:
plays in motion;
scout film/recent game film, for example, uploaded to the locker room system for view by users;
practice schedules/coaches agendas;
a list of game, directions to games, and maps of the location of the games;
a player's profile and contact information;
reports on player access and site usage;
play simulations and match up defense schemes;
weight room attendance and statistics along with tracking of trends;
player game stats, equipment/uniform assignments;
player rehab schedules/regimens;
roster and depth charts, player forms, and teams events calendar;
a team's picture gallery;
a player's highlight film for college recruiting, and
a coach's virtual game ball section.

Player information 562, team and other information 564, video and picture information 566, illustrates examples of types of information that may be placed within the locker room system 520.

Player information 562 may include player number, position, height, weight, stats, contact information, and individual work-out schedule.

Team and other information 564 may include, but is not limited to, the team roster, team schedule, maps of location of games, depth charts, team event calendar, and team statistics.

Video/picture information 566 may include game film and/or pictures of the games.

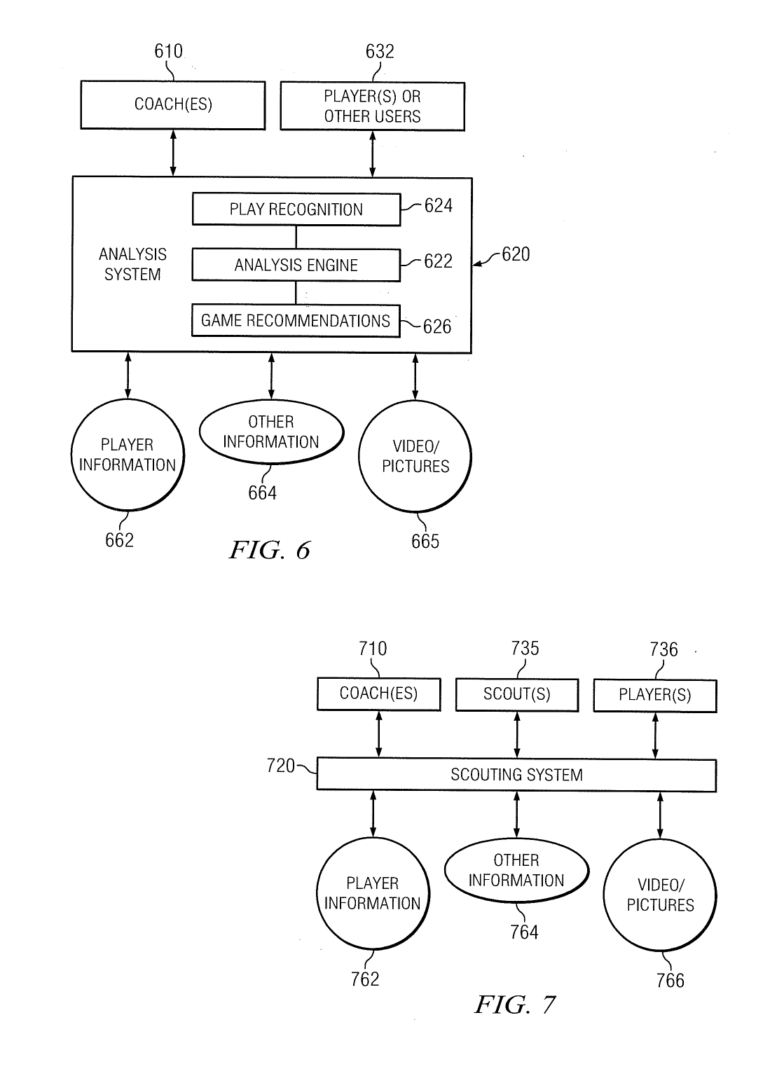

FIG. 6 illustrates an analysis system 620, according to an embodiment of the disclosure. The analysis system 620 may be used in conjunction with or separately from the other systems described herein. The analysis system 620 may be accessed in the same or different manner as the other systems described herein. For example, the users such as coach(es) 610, player(s) or other users 632 as well as the analysis system 620, itself, may correspond to endpoint(s) 110 and endpoint(s) 120 of FIG. 1. Additionally, the analysis system 620, itself, may be associated with a website that allows access to users such as coach(es) 610, player(s) or other users 632, for example, using the appropriate authentication scheme.

According to particular embodiments, the analysis system 620 may help out with perfecting game play by, among other things, making recommendations or providing statistical information based on information that the analysis system 620 has analyzed.

Information that may be placed into the system includes, but is not limited to, player information 662, video/picture information 665, and other information 664.

Player information 662 may be similar or different to the player information 562 described with reference to FIG. 5. Player information 662 may include information on the speed, size, height, vertical jumping ability, and other information on physical ability of players. In particular embodiments, player information 662 is not limited to a particular team accessing the information, but may include information on opposing teams' players.

Video/picture information 665 may also be similar or different than the video/picture information 566 described with reference to FIG. 5. The video/picture information may correspond to video/pictures corresponding a particular team's own games or the video/pictures may correspond to other teams (e.g., scouting film or pictures). As describe in further details below, the analysis system in particular embodiments may analyze ingested videos/picture information to display further yielded information.

The other information 664 may include a variety of other information that may be loaded. For example, other information 664 may include statistical information on players or the team as a whole. The other information 664 may also include information on a team's plays. For example, in particular embodiments the analysis system 620 may be integrated with other systems disclosed herein.

Additionally, other information 664 may include location game-play information. As one particular example of such location game-play information, the location of some or all of the players and ball(s) may spatially and temporally be measured and ingested into the analysis system 620. Such location game-play information contains information on the location of the players and ball(s) throughout the game. Using such information, a variety of statistics can be determined such as, but not limited to, formation of teams, speed of players, speed of ball(s), and the like.

The analysis system 620 includes an analysis engine 622, which among other things may yield play recognition information 624 and game recommendations 626.

In one particular embodiment, the analysis engine 622 takes video and/or picture information 665 and recognizes formations and plays using visual analysis techniques. As one particular example, the analysis system 622 may use software designed to recognize players and/or ball(s) and the movement of such players and/or balls during game play. Using such information, play recognition information 624 may be yielded to show not only the formation of a team, but also the movement of players in such formation, for example, in the play.

As alluded to above, in particular embodiments, location game-play information may also be ingested into the analysis system as other information 664 for a determination of plays. An example of such location game play is described in U.S. patent application Ser. No. 11/744,593. As one example, in particular embodiments, the electronic wrist coach may transmit signals. When these signals are received by three or more receivers, the location of transmission can be triangulated.

In particular embodiments, the analysis engine may have access to a particular team's playbook and capabilities (e.g., player information size, speed, and strengths) as uploaded through the player information 662, other information 664 and/or other suitable means. Using this information along with information either entered or determined for an opposing team (for one or multiple games), the analysis engine 622 may develop game recommendation information 626. For example, the analysis engine 622 may determine certain strengths and weaknesses of a team and use such information to formulate a suggested game plan. Among other items, the game plan may be certain plays or defenses that are statistically determined to be effective against a particular team.

In particular embodiments, the analysis engine 622 may also be used by a coach to determine training needed for the coach's team. For example, using the analysis engine, a team may upload their own game film and/or location information for a determination of how the team is doing and what areas needed to be worked on. As one illustrative example, for American football, a coach may determine that a particular player is not playing through the entire play or not getting off the line of scrimmage quickly enough.

Using various systems described herein, a team may also be able to provide an enhanced scouting view of a particular team. For example, using the systems described herein, a team may first show in chalkboard type format what an opposing team is attempting to do in a play. Then, the system may show example video or pictures of the same play.

FIG. 7 illustrates a scouting system 720, according to an embodiment of the disclosure. In typical college or pro-scouting scenarios, a “scout” will travel to various high schools or colleges in attempts to locate good players. Sometimes, the “scout” will review game films. Often times, these scouts may miss out on opportunities for good players because of the limiting nature of such conventional techniques. For example, a scout may not visit every school or see every player.

The scouting system 720 may be used in conjunction with or separate from the other system described herein. The scouting system 720 may be accessed in the same or different manner as the other systems described herein. For example, the users such as coach(es) 710, player(s) 736, and scouts 735 as well as the scouting system 720, itself, may correspond to endpoint(s) 110 and endpoint(s) 120 of FIG. 1. Additionally, the scouting system 720, itself, may be associated with a website that allows access to users such as coach(es) 710, player(s) 736, and scouts 735, for example, using the appropriate authentication scheme.

In particular embodiments, the scouting system 720 may serve as a central repository for scout(s) 735 to access information on potential recruits. Scout(s) 735 may be able to look at statistical information on players, stats of players and game films of players. In particular embodiments, the scouting system 720 may require ingested data (e.g., game film) to be in particular expected format. For example, a game film may only be allowed to a particular number of minutes in length.

The scouting system 720 may provide a query interface for a scout to look at information on particular players. For example, scout(s) 735 may issue a query to the scouting system 720 to show players that are (i) running backs and (ii) have a 40-speed less than 4.5 seconds. In response to this query, the scouting system 720 may display back a table of results. In particular embodiments, the table may be customized to show information on players. From the table, the each player may have a link for more information. Such a queryable repository of information may use any suitable technology as will become apparent to one of ordinary skill in the art.

In this embodiment, other information 764 and/or player information 762 may include “certified” information. Because one coach may measure player information in a different manner than another coach, “certified” measurements may be entered into the scouting system 720. As one example, regional authorized camps or centers may measure various attributes of players and enter the information into the system. Any suitable information may be measured at such camps or centers. Non-limiting examples include height, weight, 40-speed, vertical jump height, cone-drill speed, and the like.

Game statistics for particular players (either certified or not) may also come from player information 762 and/or other information 764.

As an example of integration of different systems, in particular embodiments a coach 710 may have all the game film loaded in the system, for example, from another system. A player 736 accessing the system may use video edit tools either on the scouting system 720 or on a local computing device accessible by the player 736 to create a highlight reel for the scouting system 720. The created reel for the scouting system 720 may then have capability of being seen by all scouts 735 that can access the scouting system 720. Thus, using the scouting system 720, a player that may otherwise not receive attention may receive attention because the scouts 735 may be from any number of schools.

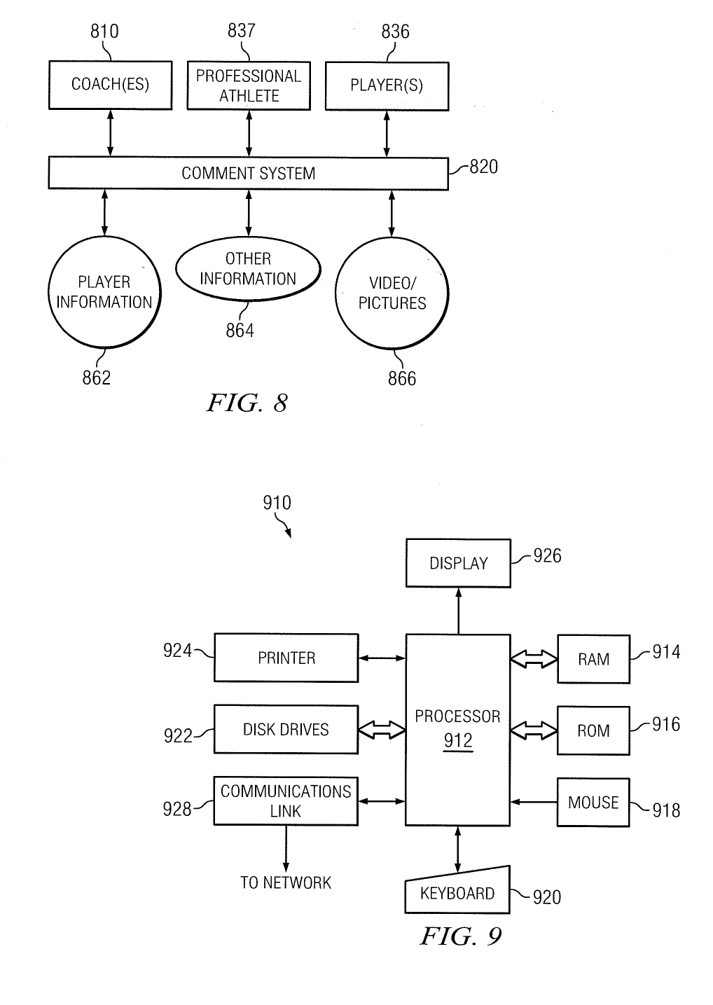

FIG. 8 illustrates a comment system 820, according to an embodiment of the disclosure. As with other embodiments, the comment system 830 may be used in conjunction with or separate from the other system described herein. The comment system 830 may also be accessed in the same or different manner as the other systems described herein. For example, the users such as coach(es) 810, player(s) 836, professional athletes 837 as well as the comment system 820, itself, may correspond to endpoint(s) 110 and endpoint(s) 120 of FIG. 1. Additionally, the comment system 820, itself, may be associated with a website that allows access to users such as coach(es) 810, player(s) 836, professional athletes 837, for example, using the appropriate authentication scheme.

The comment system 820 allows a coach and/or reviewers such as a professional athlete to review particular performance (e.g., a swing of a bat) of an athlete. The comment system 820 provides a convenient tool for certain individuals to comment on performance and other users to receive the comments.

For example, in particular embodiments, a reviewer such a professional athlete 837 or coach 810 only needs the ability to access the Internet (e.g., through a browser) in order to access the comment system 820. Once logged into the comment system 820, the coach 810 or professional athlete 837 can review video or pictures provided by, for example, a player 836 and provide comments. The comment system 820 in particular embodiments may have a variety of features to allow such comments, including, for example, voice capture, video web-cam capture, mark-up tools, and the like.

As a non-limiting example of the above, a youth baseball player may have video captured of their swing. Then, the youth baseball player uploads the video to the website. Between games, a professional athlete may log onto the system, review the uploaded video, and provide comments and/or instructions on the uploaded video. In turn, the youth baseball player may be notified that there are comments waiting for him when he logs back into the comment system 820.

Player information 862, other information 864, and video/pictures 866 are non-limiting examples of the types of information that may be loaded into the comment system. Such information may be similar or different than the other corresponding information described with reference to other others systems.

Although specific benefits have been described above, other benefits may be availed from the systems. As an example, using one or more the systems described herein, an online marketplace for plays or playbooks may also be established. In such an online marketplace, plays and/or playbooks may be purchased and/or traded between or among users. As a non-limiting example, an inexperienced coach attempting to enhance his game play may choose to purchase plays from another user on the system. The plays may be transferred (digital or otherwise) after appropriate payment verification (if purchased).

In such an online marketplace, a variety of statistics may be associated with the plays and/or playbooks including age of players associated with plays (e.g., youth, college, pro), type of formations (offense specific, defense specific), and type of plays (e.g., with regards to American football—passing, running). Other play statistics may also be associated with player credentials (e.g., good thrower, fast receiver, fast running back, good blockers).

In particular embodiments, for this online play marketplace, a sponsor may have a contest for best plays and/or playbooks whereby users submit plays and/or playbooks for judging.

Furthermore, in particular embodiments, video game outputs may be created from created plays and/or actual statistics of players (certified or not) in order to engage interest in learning the plays.

In the various embodiments described herein, certain select information may be shared with advertisers. As one non-limiting example, a video of a particularly gifted athlete may be analyzed to determine the brand of clothing that the athlete is wearing. The owner of the brand may then be contacted for information for potential opportunities in working with the gifted athlete.

Additionally, the systems described herein may also have “stickiness” where people want to spend time on the website corresponding to the system, for example, in a social networking type atmosphere. Certain sports manufacturers may want to be placed in front of users accessing such as system.

FIG. 9 is an embodiment of a general purpose computer 910 that may be used in connection with other embodiments of the disclosure to carry out any of the above-referenced functions and/or serve as a computing device for endpoint(s) 110 and endpoint(s) 120 of FIG. 1. General purpose computer 910 may generally be adapted to execute any of the known OS2, UNIX, Mac-OS, Linux, Android and/or Windows Operating Systems or other operating systems. The general purpose computer 910 in this embodiment includes a processor 912, a random access memory (RAM) 914, a read only memory (ROM) 916, a mouse 918, a keyboard 920 and input/output devices such as a printer 924, disk drives 922, a display 926 and a communications link 928. In other embodiments, the general purpose computer 910 may include more, less, or other component parts. Embodiments of the present disclosure may include programs that may be stored in the RAM 914, the ROM 916 or the disk drives 922 and may be executed by the processor 912 in order to carry out functions described herein. The communications link 928 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 922 may include a variety of types of storage media such as, for example, floppy disk drives, hard disk drives, CD ROM drives, DVD ROM drives, magnetic tape drives or other suitable storage media. Although this embodiment employs a plurality of disk drives 922, a single disk drive 922 may be used without departing from the scope of the disclosure.

Although FIG. 9 provides one embodiment of a computer that may be utilized with other embodiments of the disclosure, such other embodiments may additionally utilize computers other than general purpose computers, as well as general purpose computers without conventional operating systems. Additionally, embodiments of the disclosure may also employ multiple general purpose computers 910 or other computers networked together in a computer network. Most commonly, multiple general purpose computers 910 or other computers may be networked through the Internet and/or in a client server network. Embodiments of the disclosure may also be used with a combination of separate computer networks each linked together by a private or a public network.

Several embodiments of the disclosure may include logic contained within a medium. In the embodiment of FIG. 9, the logic includes computer software executable on the general purpose computer 910. The medium may include the RAM 914, the ROM 916, the disk drives 922, or other mediums. In other embodiments, the logic may be contained within hardware configuration or a combination of software and hardware configurations.

The logic may also be embedded within any other suitable medium without departing from the scope of the disclosure.

It will be understood that well known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A wrist coach system (220) comprising:
a layout module that provides a user (210) with menu features (232) and navigational features (236), the menu features and the navigational features configured to allow the user to create a play; and
an ouput module that provides wrist coach instructions for the created plays, the wrist coach instructions configured to be viewed from a wrist coach (310, 320) on a wrist of a player.

2. The system of claim 1, wherein:
the wrist coach is an electronic wrist coach (320),
the wrist coach instructions are transmitted wirelessly to the electronic wrist coach.

3. The system of claim 2, wherein the electronic wrist coach shows a diagram of a play.

4. The system of claim 2, wherein the wrist coach instructions that are transmitted wirelessly to the electronic wrist coach instruct the wrist coach to create an electrical shock or vibration to indicate a play or play change.

5. The system of claim 1, wherein:
the wrist coach is a print wrist coach (310).

6. The system of claim 1, wherein:
the wrist coach has different views that depend on the player wearing the wrist coach.
